(19) United States
(12) Patent Application Publication
(10) Pub. No.: US 2023/0057792 A1
(43) Pub. Date: Feb. 23, 2023

(54) TRAINING DATA FIDELITY FOR MACHINE LEARNING APPLICATIONS THROUGH INTELLIGENT MERGER OF CURATED AUXILIARY DATA

(71) Applicant: AT&T Intellectual Property I, L.P., Atlanta, GA (US)

(72) Inventors: Balachander Krishnamurthy, New York, NY (US); Subhabrata Majumdar, Jersey City, NJ (US)

(21) Appl. No.: 17/408,384

(22) Filed: Aug. 21, 2021

(51) Int. Cl. G06N 20/00; G06F 16/215

(52) U.S. Cl. CPC G06N 20/00; G06F 16/215

(57) ABSTRACT

In one example, a method includes identifying a target performance metric of a machine learning algorithm, wherein the target performance metric is to be improved, obtaining a set of auxiliary data from a plurality of auxiliary data sources, wherein the plurality of auxiliary data sources is separate from a training data set used to train the machine learning algorithm, selecting a candidate attribute type from the set of auxiliary data, identifying a quality metric for the candidate attribute type, calculating a change in the target performance metric when data values associated with the candidate attribute type are included in the training data set, determining that a tradeoff between the target performance metric and the quality metric of the candidate attribute type is satisfied by inclusion of the data values in the training data set, and training the machine learning algorithm using the training data set augmented with the data value.

The present disclosure relates generally to machine learning, and relates more particularly to devices, non-transitory computer-readable media, and methods for selecting and merging key elements from different data sources to improve the overall fidelity of data used to train machine learning algorithms.

### BACKGROUND

Machine learning is a subset of artificial intelligence encompassing computer algorithms whose outputs improve with experience. A set of sample or “training” data may be provided to a machine learning algorithm, which may learn patterns in the training data that can be used to build a model that is capable of making predictions or decisions (outputs) based on a set of inputs (e.g., new data). Machine learning models may be used to automate the performance of repeated tasks, to filter emails, to provide navigation for unmanned vehicles, and to perform numerous other tasks or actions.

### SUMMARY

The present disclosure broadly discloses methods, computer-readable media, and systems for selecting and merging key elements from different data sources to improve the overall fidelity of data used to train machine learning algorithms. In one example, a method performed by a processing system including at least one processor includes identifying a target performance metric of a machine learning algorithm, wherein the target performance metric comprises a performance metric that is to be improved, obtaining a set of auxiliary data from a plurality of auxiliary data sources, wherein the plurality of auxiliary data sources is separate from a source of a training data set that is used to train the machine learning algorithm, selecting a candidate attribute type from the set of auxiliary data, identifying a quality metric for the candidate attribute type, calculating a change in the target performance metric of the machine learning algorithm when data values associated with the candidate attribute type are included in the training data set, determining that a tradeoff between the target performance metric and the quality metric of the candidate attribute type is satisfied by inclusion of the data values associated with the candidate attribute type in the training data set, and training the machine learning algorithm using the training data set augmented with the data values associated with the candidate attribute type.

In another example, a non-transitory computer-readable medium may store instructions which, when executed by a processing system including at least one processor, cause the processing system to perform operations. The operations may include identifying a target performance metric of a machine learning algorithm, wherein the target performance metric comprises a performance metric that is to be improved, obtaining a set of auxiliary data from a plurality of auxiliary data sources, wherein the plurality of auxiliary data sources is separate from a source of a training data set that is used to train the machine learning algorithm, selecting a candidate attribute type from the set of auxiliary data, identifying a quality metric for the candidate attribute type, calculating a change in the target performance metric of the machine learning algorithm when data values associated with the candidate attribute type are included in the training data set, determining that a tradeoff between the target performance metric and the quality metric of the candidate attribute type is satisfied by inclusion of the data values associated with the candidate attribute type in the training data set, and training the machine learning algorithm using the training data set augmented with the data values associated with the candidate attribute type.

In another example, a device may include a processing system including at least one processor and a non-transitory computer-readable medium storing instructions which, when executed by the processing system, cause the processing system to perform operations. The operations may include identifying a target performance metric of a machine learning algorithm, wherein the target performance metric comprises a performance metric that is to be improved, obtaining a set of auxiliary data from a plurality of auxiliary data sources, wherein the plurality of auxiliary data sources is separate from a source of a training data set that is used to train the machine learning algorithm, selecting a candidate attribute type from the set of auxiliary data, identifying a quality metric for the candidate attribute type, calculating a change in the target performance metric of the machine learning algorithm when data values associated with the candidate attribute type are included in the training data set, determining that a tradeoff between the target performance metric and the quality metric of the candidate attribute type is satisfied by inclusion of the data values associated with the candidate attribute type in the training data set, and training the machine learning algorithm using the training data set augmented with the data values associated with the candidate attribute type.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for selecting and merging key elements from different data sources to improve the overall fidelity of data used to train machine learning algorithms may operate;

FIG. 2 illustrates a flowchart of an example method for selecting and merging key elements from different data sources to improve the overall fidelity of data used to train machine learning algorithms, in accordance with the present disclosure;

FIG. 3 illustrates one example of a set of auxiliary data that may be obtained in accordance with the method of FIG. 2; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for selecting and merging key elements from different data sources to improve the overall fidelity of data used to train machine learning algorithms. As discussed above, machine learning algorithms are trained using a set of training data to make predictions or decisions (outputs) based on a set of inputs (e.g., new data). However, if the training data contains inaccuracies or is incomplete, then the resulting machine learning algorithm may produce outputs that are flawed. The damage to the output may disparately impact the class of inaccurate or incomplete data (or similar data). This can have negative consequences for critical algorithmic decision making processes, such as credit approvals, image classification, and other processes.

Consider, for instance, the difficulty of obtaining accurate information about individuals, businesses, or organizations by searching existing information. On the Internet, there are few large vetted databases from which information can be reliably sourced. For instance, some Internet databases are large, but the accuracy of their records is variable. Other databases may contain more accurate information, but may be smaller and may have a narrower schema.

As an example, a database of the one thousand best films could be hand curated to associate a dozen attributes (e.g., director, release date, genre, worldwide box office receipts, etc.) with each film in the database. In this way, the information contained in the database is fully vetted and can be considered to be reliable. However, a user who is looking for information about a film that is not included in the one thousand best films would not be able to use this database. Instead, the user might rely on a much larger database which might include entries for more than one million films, where each entry might include a broader set of attributes. However, some of the attribute fields for the entries in this larger database may be more likely to contain inaccuracies, especially if users are permitted to upload individual entries to the database. Although the best known films in this larger database may be vetted for accuracy, there may be less of an incentive to vet the entries for the films which are not as well known or as frequently accessed.

Examples of the present disclosure select and merge attribute types from different databases to improve the overall fidelity of a merged database. In one example, a narrow subset of attribute types is identified and curated using machine learning and multiple existing data sets to select the best combination of attribute types and to improve specific metrics that function as measures of accuracy or reliability of the data. In further examples, voting mechanisms can be employed to improve the selection of attribute types for merger into the merged database.

For instance, a machine learning algorithm may be trained using a set of training data to optimize a selected business metric. The training data may include a plurality of entries, where each entry is associated with a plurality of attributes. The creator of the machine learning algorithm may want to explore the possibility of adding additional attribute types from one or more auxiliary data sets to these entries, so that the machine learning algorithm can be further optimized for additional metrics (while also possibly improving the original business metric). Each auxiliary data set may include a plurality of entries, where each entry may include values for a plurality of attribute types. Each attribute type may be further associated with a quality metric. Under these circumstances, examples of the present disclosure would attempt to strike a balance between: (1) the set of optimal values of all metrics resulting from the integration of the additional attribute types from specific auxiliary data sets; and (2) the set of quality metrics associated with the additional attribute types.

One possible way to balance the above considerations would be to select attribute types that improve the desired business metric(s), even if the quality metrics associated with the attribute types are not particularly high. The selection of the attribute types on this case might be guided by domain knowledge (e.g., from a human subject matter expert who knows how to prioritize attribute types to obtain improvements in certain business metrics). Another possible way to balance the above considerations would be to automate the attribute type selection (e.g., using machine learning techniques such as model selection, model averaging, or hyperparameter tuning which involve evaluating a number of machine learning models and choosing one or more of the machine learning models based on performance on the desired business metric(s)). In another example, the combined quality metrics of the attributes being considered may be tuned to achieve an optimal tradeoff of model performance and fidelity/quality of the combined dataset.

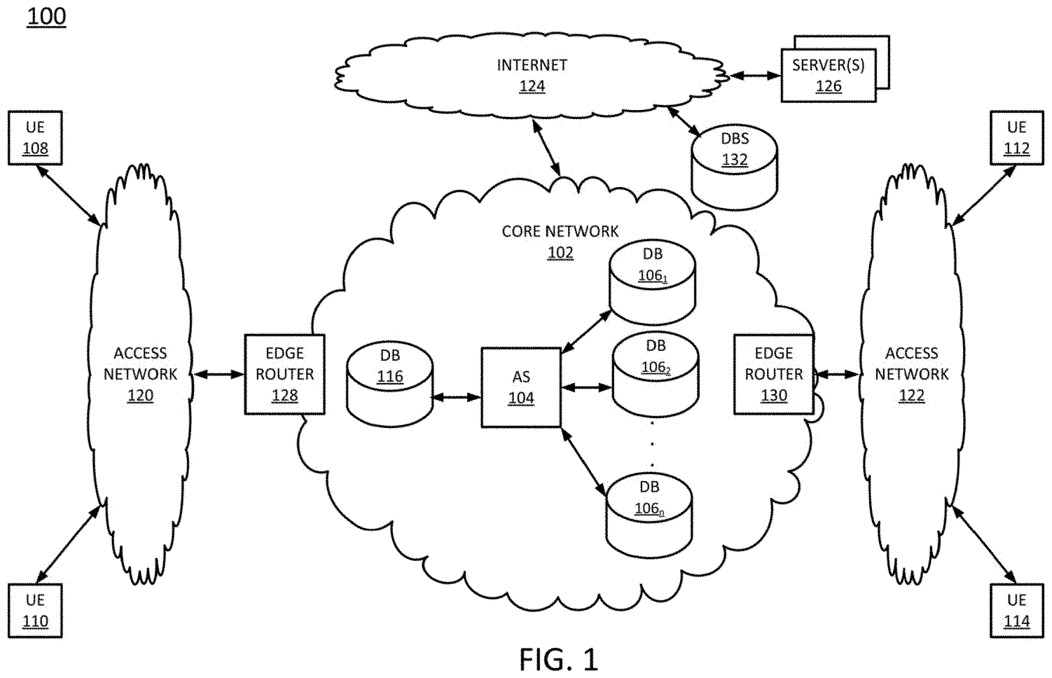

Thus, examples of the present disclosure automatically select the attribute types that should be vetted for accuracy by focusing on the semantics of the attribute fields in a manner that is tailored to the machine learning use case at hand. A list of attribute types, ranked in order of desired accuracy, may be provided along with acceptable accuracy thresholds for each attribute type. The rankings may be needed, because not all attribute types are likely to be of equal importance or to contribute equally to the desired improvement in the metric being maximized. Examples of the present disclosure may iterate over the attribute types that have the greatest influence on the metric being maximized. The final selection of both the attribute types to add to the merged database and the degree of improvement in the metric being maximized will result in improved overall prediction quality for the machine learning algorithm being trained. These and other aspects of the present disclosure are discussed in greater detail below in connection with the examples of FIGS. 1-4.

To further aid in understanding the present disclosure, FIG. 1 illustrates an example system 100 in which examples of the present disclosure for selecting and merging key elements from different data sources to improve the overall fidelity of data used to train machine learning algorithms may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, a training data set (DB) 116, a plurality of auxiliary databases (DBs) or data sources 106₁-106n (hereinafter individually referred to as a “database 106” or collectively referred to as “databases 106”), and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

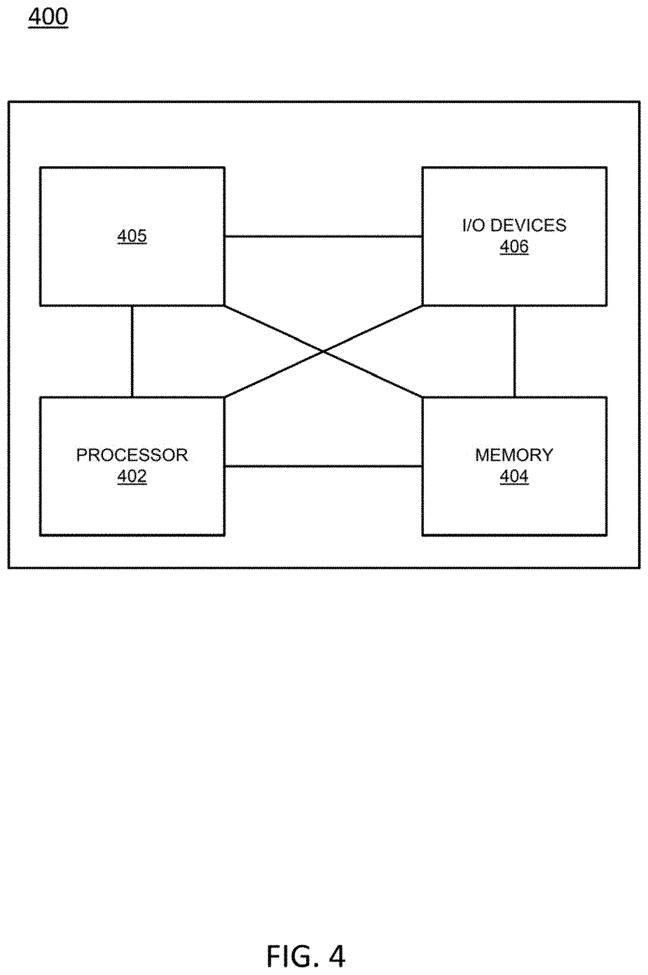

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 400 depicted in FIG. 4, and may be configured as described below. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like. In one example, any one of the user endpoint devices 108, 110, 112, and 114 may be operable by a human user to provide guidance and feedback to the AS 104, which may be configured to select and merge key elements from different data sources (e.g., DBs 106) to improve the overall fidelity of data used to train machine learning algorithms (e.g., training data set 116), as discussed in greater detail below.

In one example, one or more servers 126 and one or more databases 132 may be accessible to user endpoint devices 108, 110, 112, and 114 and to AS 104 via Internet 124 in general. The server(s) 126 and DBs 132 may be associated with Internet content providers, e.g., entities that provide content (e.g., news, blogs, videos, music, files, products, services, or the like) in the form of websites (e.g., social media sites, general reference sites, online encyclopedias, or the like) to users over the Internet 124. Thus, some of the servers 126 and DBs 132 may comprise content servers, e.g., servers that store content such as images, text, video, and the like which may be served to web browser applications executing on the user endpoint devices 108, 110, 112, and 114 and/or to AS 104 in the form of websites.

In accordance with the present disclosure, the AS 104 may be configured to provide one or more operations or functions in connection with examples of the present disclosure for selecting and merging key elements from different data sources to improve the overall fidelity of data used to train machine learning algorithms, as described herein. The AS 104 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the AS 104 may be configured to train machine learning models by providing training data to one or more machine learning algorithms. In one example, the training data may be stored in a master database as training data set 116. The AS 104 may be configured to calculate a performance metric associated with the output of a machine learning algorithm and to augment the training data set 116 with selected data attribute types extracted from the auxiliary DBs 106 and/or DBs 132 in order to improve the performance metric.

For instance, each of the DBs 106 and 132 may operate as an auxiliary data source that contains information of varying reliability, type, and/or quantity. As an example, some of the auxiliary data sources may comprise commercial databases that contain data relating to specific industries or subjects, while other auxiliary data sources may comprise crowd-sourced online encyclopedias which allow any user to upload data about any subject. New auxiliary data sources may be added at any time to the set of DBs 106. Moreover, existing DBs may be updated at any time to include new data.

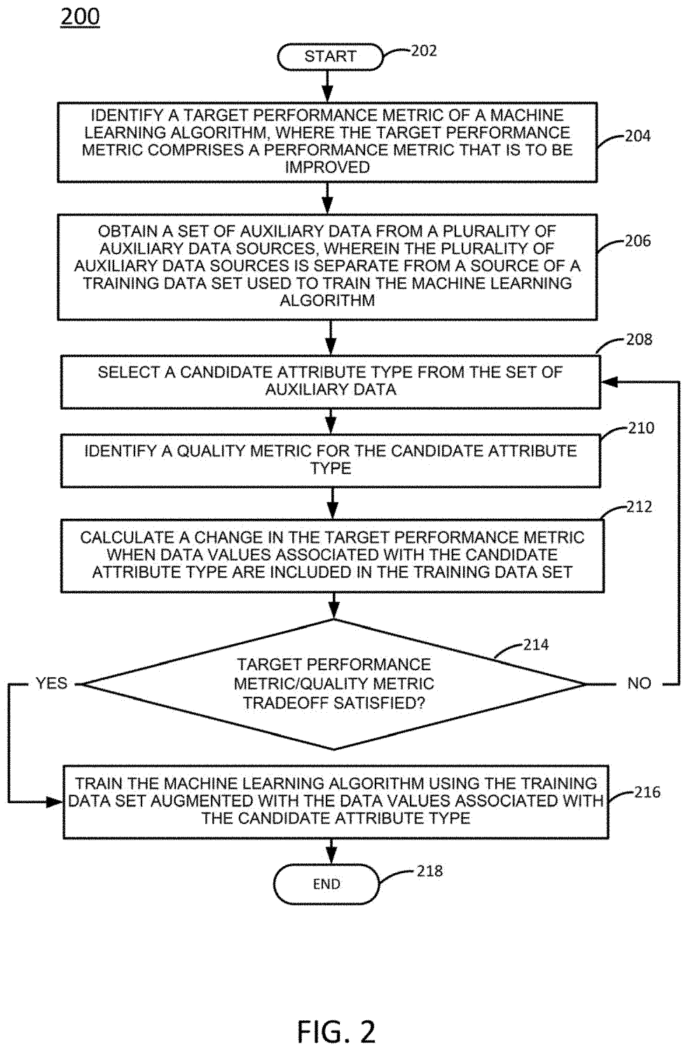

In one example, the DBs 106 may comprise physical storage devices integrated with the AS 104 (e.g., a database server or a file server), or attached or coupled to the AS 104, in accordance with the present disclosure. In one example, the AS 104 may load instructions into a memory, or one or more distributed memory units, and execute the instructions for selecting and merging key elements from different data sources to improve the overall fidelity of data used to train machine learning algorithms, as described herein. One example method for selecting and merging key elements from different data sources to improve the overall fidelity of data used to train machine learning algorithms is described in greater detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for selecting and merging key elements from different data sources to improve the overall fidelity of data used to train machine learning algorithms, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system in an Internet service provider network, such as processing system 402.

The method 200 begins in step 202 and proceeds to step 204. In step 204, the processing system may identify a target performance metric of a machine learning algorithm, where the target performance metric comprises a performance metric that is to be improved (e.g., for which improvement is desired, as indicated by a human analyst). The target performance metric may vary depending on the use case for the machine learning algorithm (e.g., what types of predictions the machine learning algorithm is being trained to make). Some examples of performance metrics for which improvement may be sought include diversity and inclusion metrics (e.g., consideration of more inclusive and/or diverse data when generating an output), metrics that measure the accuracy of the machine learning output, revenue metrics, and other types of metrics. In one example, the performance metric may be identified in accordance with a signal provided by a human operator or analyst, where the signal indicates which performance metric(s) the processing system should seek to improve.

In one example, the machine learning algorithm may be an algorithm that is selected based at least in part on the purpose (e.g., use case(s)) of the machine learning algorithm. For instance, the machine learning algorithm may comprise a deep learning algorithm, a neural network, or another type of machine learning algorithm. The purpose of the machine learning model may be to automate the performance of repeated tasks, to filter emails, to provide navigation for unmanned vehicles, or to perform other tasks or actions.

In one example, the machine learning algorithm has been trained, using a training data set, to produce an output (e.g., prediction) that corresponds to a provided input. For instance, the output of the machine learning algorithm may comprise one or more of: generated content (e.g., text, audio, video, or the like), a list of samples (e.g..

data) prioritized by the machine learning algorithm (e.g., users, groups of user segments, enterprise or individual customers, or entities such as movies, television shows, advertisers, and the like), or a set of attributes and values considered important or of high value by a machine learning algorithm and/or domain knowledge. The training of the machine learning algorithm may be supervised (i.e., in which the data items of the training data set are labeled to guide learning) or unsupervised (i.e., in which the data items of the training data set are unlabeled). The training data set may be stored in a single master database (e.g., such as DB 116 of FIG. 1) or across multiple master databases (e.g., multiple instances of the DB 116).

In step 206, the processing system may obtain a set of auxiliary data from a plurality of auxiliary data sources, where the plurality of auxiliary data sources is separate from the source of the training data set that is used to train the machine learning algorithm. As discussed above, the machine learning algorithm is trained to make predictions based on a training data set from which the machine learning algorithm learns to map inputs to outputs. The training data set may be stored in a master database. The auxiliary data sources, however, may be different from this master database and may contain data that is not contained in the training data set.

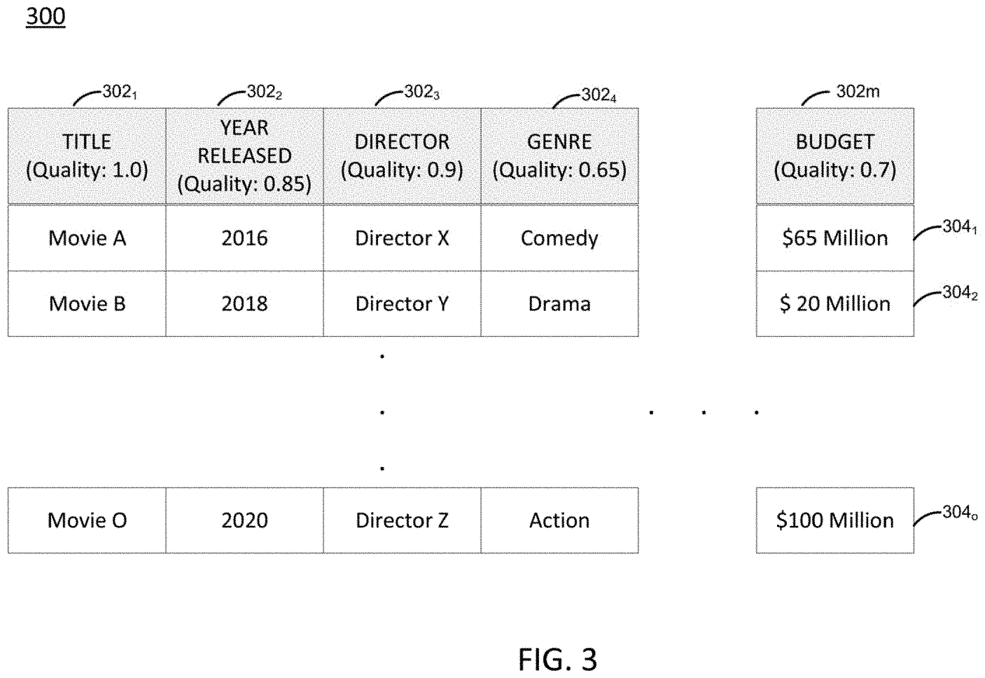

FIG. 3 illustrates one example of a set 300 of auxiliary data that may be obtained in accordance with the method 200 of FIG. 2. As illustrated, the set 300 of auxiliary data may be organized into a plurality of columns 302₁-302ₘ (hereinafter individually referred to as a “column 302” or collectively referred to as “columns 302”) and a plurality of rows 304₁-304ₒ (hereinafter individually referred to as a “row 304” or collectively referred to as “rows 304”). In the example illustrated, each row 304 of the set 300 of auxiliary data may contain an entry for a different entity (in this case, a movie, such as Movie A, Movie B, . . . , Movie O), while each column 302 of the set 300 of auxiliary data may contain values for a different type of attribute for a plurality of entities (e.g., in this case title, year released, director, genre, budget, etc.). Thus, each column 302 may contain the values of a different attribute type for all of the entities for which the set 300 of auxiliary data contains information.

It should be noted that while an auxiliary data source is separate or different from the training data set, this does not necessarily mean that the contents of the auxiliary data source and the contents training data set are mutually exclusive. In other words, there may be some overlap in the contents of the auxiliary data source and the contents training data set (e.g., some data items or values may occur in both the auxiliary data source and the training data set). However, the contents of the auxiliary data source and the contents of the training data set are not identical (e.g., the auxiliary data source may contain data items not contained in the training data set, and/or the training data set may contain data items not contained in the auxiliary data source). For instance, the training data set may contain a number of (e.g., x) data items pertaining to female data scientists, while the auxiliary data source may contain a greater number of (e.g., x+y) data items pertaining to female data scientists.

Referring back to FIG. 2, in step 208, the processing system may select a candidate attribute type from the set of auxiliary data. For instance, for the set 300 of auxiliary data illustrated in FIG. 3, any of the attribute types or columns 302 (e.g., title, year released, director, genre, budget, etc.) may potentially be a candidate attribute type. The processing system may select one or more of these attribute types or columns as a candidate attribute type. In one example, the candidate attribute type may be selected based on the use case for the machine learning algorithm (e.g., certain attribute types may be known or believed to influence a greater improvement in the target performance metric). In another example, the candidate attribute type may be selected in response to a signal from a human analyst that instructs the processing system to select the candidate attribute type.

In step 210, the processing system may identify a quality metric for the candidate attribute type that is selected in step 208. Referring back to FIG. 3, in one example, each column 302 of the set 300 of auxiliary data may also include a quality metric that indicates a degree of accuracy of the values the column 302 contains. In one example, the degree of accuracy may be expressed as a confidence, such as a percentage between zero and one hundred (where zero indicates a smallest possible degree of accuracy and one hundred indicates a greatest possible degree of accuracy).

In one example, the quality metric associated with a column 302 may be pre-computed prior to the processing system searching the auxiliary data source. The quality metric may be pre-computed based on some evaluation of the values contained in the column 302 (where the evaluation may be performed by the owner of the auxiliary data source). For instance, a machine learning model may be trained to assign quality metrics to attributes based on analysis of similar historical data (i.e., attributes and associated quality metrics that have been vetted). In another example, the quality metric may be pre-computed based on a source of the values (e.g., greater confidence may be given to movie information provided by a major movie studio than to movie information provided by a fan or individual).

In another example, the quality metric may be crowdsourced. In this case, the quality metric may be higher or lower depending on (e.g., directly proportional to) the number of respondents who agree on the value to which the quality metric pertains. For instance, if ninety percent of respondents classify the genre of a film as “comedy,” and the comedy classification is more than a threshold percentage higher than any classifications submitted by the remaining ten percent of respondents, then the degree of confidence associated with the comedy classification (and, hence, the quality metric) will be relatively high. However, if the studio which produced the film classifies the film as a comedy, then the confidence in the studio-provided classification may be even greater (e.g., one hundred percent). In another example, a subset of trusted respondents (e.g., vetted domain experts) may automatically be associated with higher confidences (or weights) in their classifications relative to other respondents who are not members of the subset (e.g., similar to “top critics” on a movie review web site).

Different methods of labeling can also be used for different auxiliary data sources. For instance, for an auxiliary data source containing resumes, individual resumes may be labeled with values or attributes like “top five,” “top ten,” “team player,” and the like.

In another example, third party sources may be cross referenced with the auxiliary data source in order to generate the quality metric. For instance, if the auxiliary data source contains resumes, the colleges and universities listed on the individual resumes may be cross referenced against a list of college and university rankings from a reputable source. Thus, the quality metric for each attribute in each type of auxiliary data source may be computed in different ways.

In another example, the quality metric associated with a column 302 may be computed by the processing system when the processing system searches the auxiliary data source. For instance, the processing system may look up values for a specific attribute type in multiple different auxiliary data sources. If a majority of the multiple different auxiliary data sources assign the same values for the specific attribute type to the same entities (e.g., a majority of the multiple different auxiliary data sources agree that Movie A was released in 2016, Movie B was released in 2018, and Movie O was released in 2020), then the columns corresponding to the specific attribute type in the agreeing auxiliary data sources can be assigned a relatively high quality metric. Conversely, the columns corresponding to the specific attribute type in the auxiliary data sources that do not agree may be assigned relatively low quality metrics. Thus, the quality metric may be directly proportional to a number of the auxiliary data sources containing values that agree (e.g., match within some threshold) with the data values associated with the candidate attribute type.

If the processing system is unable to find any agreement among the multiple auxiliary data sources (e.g., each auxiliary data source contains a different release date for Movie A, Movie B, and Movie O), then the processing system may attempt to vet the values by either crowdsourcing values for the specific attribute type, delivering a focused survey to a group of known subject matter experts (e.g., movie critics), or by other means. For instance, higher quality metrics may be assigned to data values that match crowdsourced values or values provided by subject matter experts. In this way, the processing system may be able to ensure a high degree of confidence in the values provided by a particular auxiliary data source even when a guarantee of accuracy is impossible.

Referring back to FIG. 2, in step 212, the processing system may calculate a change in the target performance metric of the machine learning algorithm when data values associated with the candidate attribute type are included in the training data set. For instance, the processing system may re-train the machine learning algorithm and check the output of the re-trained algorithm to see if the target performance metric has been improved. The inclusion of different candidate attribute types (or combinations of candidate attribute types) may result in different effects on the target performance metric. For example, not all attribute types will have equal influence on the output of the machine learning algorithm; some attribute types may contribute to greater change than others. In addition, different candidate attribute types may be associated with different quality metrics as discussed above (e.g., may be considered more accurate or more reliable than other candidate attribute types). Thus, where a candidate attribute type is more influential than most on the machine learning output, but the values for the candidate attribute type are associated with a relatively low quality metric, a decrease in the target performance metric may actually be observed. Conversely, where the quality metric associated with a candidate attribute type is very high, but the candidate attribute type has relatively little influence on the machine learning output, the target performance metric may not be improved very much even though the quality metric is very high. Thus, as discussed above, there may be a tradeoff between the quality metric and influence of the candidate attribute type and the resulting change in the target performance metric when the data values associated with the candidate attribute type are included in the training data set.

In step 214, the processing system may determine whether a tradeoff between the target performance metric and the quality metric of the candidate attribute type is satisfied by inclusion of the data values associated with the candidate attribute type in the training data set. In one example, the determination may be made by consulting with a human analyst. For instance, the processing system may receive a signal from a human analyst indicating that the tradeoff is satisfied. In another example, the tradeoff may be satisfied when an improvement in the target performance metric at least meets a first threshold (e.g., a threshold metric or a threshold increase in the metric) and when the quality metric of the candidate attribute type at least meets a second threshold (e.g., a threshold confidence).

If the processing system concludes in step 214 that the tradeoff has not been satisfied, then the method 200 may return to step 208, and the processing system may select a new candidate attribute type from the set of auxiliary data. The method 200 may then proceed as described above to determine whether inclusion of data values associated with the new candidate attribute type in the training data set satisfies the predefined tradeoff.

The processing system may iterate any number of times through steps 208-214 attempting to satisfy the predefined tradeoff. In some examples, a predefined stopping criterion may limit the number of times that the processing system may iterate through steps 208-214. The stopping criterion may, in one example, comprise a limit on a number of iterations (e.g., if the predefined tradeoff is not satisfied after x iterations, go to step 218 and end). As an alternative to ending after a maximum number of iterations, the processing system may instead select the best possible outcome from those iterations, even if the predefined tradeoff is not quite satisfied. In another example, the stopping criterion may comprise a predefined minimum quality value for a specific attribute.

In one example, if the processing system iterates through steps 208-214 a maximum number of times and cannot satisfy the predefined tradeoff, and the use case is a high-priority use case (or the inaccurate/incomplete data is highly influential), then this may trigger an effort to prioritize improvement of the data quality for the attributes at issue.

Referring back to step 214, if the processing system concludes in step 214 that the predefined tradeoff has been satisfied, then the method 200 may proceed to step 216. In step 216, the processing system may train the machine learning algorithm using the training data set augmented with the data values associated with the candidate attribute type. The data values associated with the candidate attribute type may be stored with the training data set (to create an augmented training data set) as part of the training in step 214.

The method 200 may end in step 218. However, in another example, the method 200 may return to step 204 after step 216. In this case, the method 200 may iterate through steps 204-216 to continuously improve one or more performance metrics of the machine learning algorithm.

Thus, the method 200 augments the training data set with selected auxiliary data from one or more auxiliary data sources. That is, rather than augment the training data set with all of the data contained in an auxiliary data source, examples of the present disclosure augment with a curated collection of selected data (e.g., attribute types or columns) from the auxiliary data source. Moreover, although the method 200 discusses the evaluation and inclusion of a single candidate attribute type, it will be appreciated that multiple candidate attribute types may be evaluated and used to augment the training data set. For instance, different combinations of candidate attribute types (potentially having different quality metrics) may result in even greater improvement to the target performance metric than any single candidate attribute type alone.

It should be noted that although a goal of the method 200 is to improve the target performance metric, performance of the method 200 may not always result in an improvement in the target performance metric. In other words, augmentation of the training data set with data from the auxiliary data source may provide a greater likelihood of an improvement in the target performance metric, but does not guarantee an improvement in the target performance metric. Whether or not the target performance metric is improved may depend on the quality of the target performance metric to begin with, the type, quality, and amount of auxiliary data available, and/or other factors.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

Thus, in some examples, the method 200 may select and merge attributes from different data sources to improve the overall fidelity of a merged database. In one example, a narrow subset of problematic attribute types is identified and hand curated using machine learning and multiple existing data sets to select the best combination of attribute types and to improve specific metrics that function as measures of accuracy or reliability of the data contained in the merged database. As such, the purposeful, selective inclusion of specific auxiliary data (e.g., values for specific attribute types) may improve the performance of a machine learning algorithm (as measured by a particular metric) by improving the quality of the training data set that is used to train the machine learning algorithm.

For instance, examples of the present disclosure could be used to improve diversity and inclusion metrics while potentially improving the overall predictive value of a machine learning algorithm's output. In this case, improvement in the metrics may be evaluated on the basis of accuracy, revenue, or other tangible attributes. Before merging data from multiple auxiliary data sources, the schemas of the auxiliary data sources may be examined to narrow the focus to data elements that are most significant to the machine learning task at hand. For instance, the task at hand may be identifying potential candidates (e.g., actors, directors, composers, etc.) for a new film project, and the auxiliary data sources may comprise collections of files containing information about actors, directors, and other film artists.

In one example, the three most important attribute types required from the auxiliary databases may comprise gender, race, and worldwide revenue of prior films (e.g., a mean or median revenue of all prior films, a highest revenue of all prior films, etc.). These three attribute types may be extracted from the auxiliary data sources and sampled for accuracy against any present ground truth. The accuracy of the attribute types may vary from auxiliary data source to auxiliary data source. A new merged database may be created that includes the values (e.g., columns) from each of the auxiliary data sources for which the values in the attribute types of interest were most accurate. In other words, for each attribute type of interest, the auxiliary data source for which the values are most accurate may be identified, and those values may be extracted and merged into the merged database. This merged database may then be used to train the machine learning algorithm with an eye toward improving the quality of the machine learning algorithm's predictions (as measured by the diversity and inclusion metrics).

In addition, if one specific attribute type (e.g., gender) is determined to influence an improvement in the predictions more than other attribute types, this may validate the usefulness of the particular auxiliary data source whose values exhibited the greatest accuracy for the specific attribute type. Thus, it may be worthwhile to direct resources toward improving the quality of that particular auxiliary data source.

In the above example, the attribute types of interest may be ranked in order of decreasing importance and accuracy constraints (e.g., desired thresholds) as: race, revenue, and gender. Examples of the present disclosure may select the best combinations of these attribute types from among the multiple auxiliary databases, subject to the rank ordering and accuracy constraints. By iterating over the choices and ensuring that all attribute values merged into the merged database satisfy the accuracy constraints (e.g., accuracy at least meets a threshold), it can be ensured that the resulting merged database will contain the most improved and best attribute values that will maximize the object function of satisfying the diversity and inclusion metrics.

Other examples of the present disclosure may be used to validate self-identification information (i.e., identifying or descriptive information that is provided by the individual who the information describes). Many organizations rely on self-identification information to improve service to customers; thus, the quality of the service provided may be directly impacted by the accuracy of the self-identification information that is available. Unfortunately, customer participation rates may vary widely. For instance, some customers may be hesitant to provide certain types of information or may find the process cumbersome if too much information is requested. Even among customers who do choose to provide self-identification information, the accuracy of the information provided may be difficult to verify.

By implementing examples of the present disclosure to identify and combine existing data that meets a specific quality threshold, an organization may be able to request minimal information from customers and to automatically validate the customers' responses to the requests. This approach may prove both more efficient and more reliable than existing approaches. For instance, a customer might be much more willing to provide corrections (if needed) to a set of information that has already been compiled than to provide the information from scratch. In addition, this approach freely provides insight into which data fields are corrected by customers most frequently. Further examples of the present disclosure can learn from these customer-provided corrections and consequently focus on improving the acquisition of data for the most frequently corrected data fields. The quality metrics associated with the auxiliary data sources from which data is acquired can also be adjusted in response to the rate of customer corrections. For instance, if values extracted from a particular data field of a particular auxiliary data source are frequently corrected by customers, then the quality metric associated with the particular auxiliary data source and/or particular data field may be lowered to reflect a lesser degree of data reliability.

In some examples, existing sources of verified quality information may be utilized as auxiliary data sources. For instance, an online encyclopedia which employs hundreds of individuals to maintain pages which are frequently accessed is likely to be a more trustworthy source of information than a commercial database which may not be as frequently vetted. However, commercial databases may also be relatively trustworthy sources of information given the fact that poor information quality may cause their commercial value to decrease.

As discussed above, demographic self-identification information can be collected via surveys that utilize numerous open-ended questions to ask for demographic information (e.g., race, gender, ethnic background, etc.). For instance, political campaigns may utilize such surveys collect data relating to various demographic attributes of the political candidates, such as race, gender, age, immigration status, and incumbency, and campaign finance. If a candidate does not provide a response to a particular question, auxiliary data sources such as biographies posted on campaign web sites, media interviews, summaries from non-governmental organizations (NGOs), and other crowdsourced data sources may be consulted to provide the missing information. Any specific attribute types that are less available in the self-identification information may be extracted from these auxiliary data sources and presented to the candidate for vetting.

In the above example use case, a higher quality merged database of self-identification information could be obtained by focusing one or two key attribute types in the auxiliary data sources and then vetting the accuracy of the key attributes by comparing to other sources for ground truth. Sources for ground truth may vary based on the type of information and use case at issue. For instance, when vetting information relating to public figures such as celebrities, a commercial video sharing platform that allows users to purchase personalized video messages from celebrities may provide ground truth information for the celebrities who utilize the platform (and therefore set their own prices and manners of customer interaction). The individual celebrities on whom information is being collected can be grouped into tiers or categories that are prioritized to encourage the individual celebrities to provide self-identification information. Similarly, a commercial database that maintains information on films, television shows, artist filmographies, and box office data may be consulted for missing demographic data.

Thus, examples of the present disclosure may provide numerous technical and commercial benefits. For instance, in industrial machine learning workflows, construction of training data sets tends to rely heavily on data reuse and large-scale data joins. Examples of the present disclosure provide a novel approach to performing data reuse and data joins in a manner that tailors the final training data set to obtain optimized prediction metrics. The final training data set is also made up of values that are high-quality (i.e., reliable) representations of the attributes the values quantify. Some direct benefits of the disclosed approach include the effective reuse of existing data and the resulting efficiency gain in downstream business processes. Additionally, the proactive redressal of data quality issues may be implemented as a set of follow-up steps after discovery of specific data sets or specific attribute types within data sets which are determined to be important in certain machine learning contexts, but whose values are of relatively low quality (i.e., low reliability).

Moreover, as machine learning algorithms take on a greater role in the standard operating procedures of various industries, large-scale data collection, use, and sharing is becoming increasingly common in the training and evaluation phases of such algorithms. Within this context, examples of the present disclosure may connect the two often disparate dimensions of data quality and business metrics. For instance, examples of the present disclosure may provide a systematic process to balance these dimensions in an efficient manner. Moreover, examples of the present disclosure may enable new methods proposed by recent advances in machine learning research, so that new methods of cross-model comparison and aggregation can be seamlessly implemented to strengthen and update the examples disclosed herein.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for selecting and merging key elements from different data sources to improve the overall fidelity of data used to train machine learning algorithms, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 400 as discussed above is implemented in a distributed or parallel manner fora particular illustrative example, i.e., the steps of the above method 400 or the entire method 400 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for selecting and merging key elements from different data sources to improve the overall fidelity of data used to train machine learning algorithms (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for selecting and merging key elements from different data sources to improve the overall fidelity of data used to train machine learning algorithms (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor, a target performance metric of a machine learning algorithm, wherein the target performance metric comprises a performance metric that is to be improved;
obtaining, by the processing system, a set of auxiliary data from a plurality of auxiliary data sources, wherein the plurality of auxiliary data sources is separate from a source of a training data set that is used to train the machine learning algorithm;
selecting, by the processing system, a candidate attribute type from the set of auxiliary data;
identifying, by the processing system, a quality metric for the candidate attribute type;
calculating, by the processing system, a change in the target performance metric of the machine learning algorithm when data values associated with the candidate attribute type are included in the training data set;
determining, by the processing system, that a tradeoff between the target performance metric and the quality metric of the candidate attribute type is satisfied by inclusion of the data values associated with the candidate attribute type in the training data set; and
training, by the processing system, the machine learning algorithm using the training data set augmented with the data values associated with the candidate attribute type.

2. The method of claim 1, wherein the target performance metric relates to a use case for the machine learning algorithm.

3. The method of claim 1, wherein the target performance metric is identified in a signal provided by a human analyst.

4. The method of claim 1, wherein the plurality of auxiliary data sources contains data that is not contained in the training data set.

5. The method of claim 1, wherein the candidate attribute type is selected based on a use case for the machine learning algorithm.

6. The method of claim 5, wherein the candidate attribute type is known to influence an improvement in the target performance metric for the use case.

7. The method of claim 1, wherein the candidate attribute type is selected in response to a signal from a human analyst that instructs the processing system to select the candidate attribute type.

8. The method of claim 1, wherein the quality metric indicates a degree of accuracy of the data values associated with the candidate attribute type.

9. The method of claim 8, wherein the degree of accuracy is expressed as a confidence.

10. The method of claim 1, wherein the quality metric is pre-computed prior to the processing system selecting the candidate attribute type.

11. The method of claim 1, wherein the quality metric is computed by the processing system.

12. The method of claim 11, wherein the quality metric is directly proportional to a number of the plurality of auxiliary data sources containing values that agree with the data values associated with the candidate attribute type.

13. The method of claim 11, wherein the quality metric depends on how closely the data values associated with the candidate attribute type match crowdsourced values for the candidate attribute type.

14. The method of claim 11, wherein the quality metric depends on how closely the data values associated with the candidate attribute type match values obtained from a focused survey delivered to a group of known subject matter experts.

15. The method of claim 1, wherein the calculating comprises:
re-training, by the processing system, the machine learning algorithm with the data values associated with the candidate attribute type included in the training data set.

16. The method of claim 1, wherein the candidate attribute type results in the change in the target performance metric being greater than other candidate attribute types which have been evaluated for inclusion in the training data set.

17. The method of claim 1, wherein the determining is based on a consultation with a human analyst.

18. The method of claim 1, wherein the tradeoff is satisfied when the change in the target performance metric is an improvement that at least meets a first threshold and when the quality metric of the candidate attribute type at least meets a second threshold.

19. A non-transitory computer-readable medium storing instructions which, when executed by a processing system including at least one processor, cause the processing system to perform operations, the operations comprising:
identifying a target performance metric of a machine learning algorithm, wherein the target performance metric comprises a performance metric that is to be improved;
obtaining a set of auxiliary data from a plurality of auxiliary data sources, wherein the plurality of auxiliary data sources is separate from a source of a training data set that is used to train the machine learning algorithm;
selecting a candidate attribute type from the set of auxiliary data;
identifying a quality metric for the candidate attribute type;
calculating a change in the target performance metric of the machine learning algorithm when data values associated with the candidate attribute type are included in the training data set;
determining that a tradeoff between the target performance metric and the quality metric of the candidate attribute type is satisfied by inclusion of the data values associated with the candidate attribute type in the training data set; and
training the machine learning algorithm using the training data set augmented with the data values associated with the candidate attribute type.

20. A device comprising:
a processing system including at least one processor; and
a non-transitory computer-readable medium storing instructions which, when executed by the processing system, cause the processing system to perform operations, the operations comprising:
identifying a target performance metric of a machine learning algorithm, wherein the target performance metric comprises a performance metric that is to be improved;
obtaining a set of auxiliary data from a plurality of auxiliary data sources, wherein the plurality of auxiliary data sources is separate from a source of a training data set that is used to train the machine learning algorithm;
selecting a candidate attribute type from the set of auxiliary data;
identifying a quality metric for the candidate attribute type;
calculating a change in the target performance metric of the machine learning algorithm when data values associated with the candidate attribute type are included in the training data set;
determining that a tradeoff between the target performance metric and the quality metric of the candidate attribute type is satisfied by inclusion of the data values associated with the candidate attribute type in the training data set; and
training the machine learning algorithm using the training data set augmented with the data values associated with the candidate attribute type.
